(19) United States
(12) Patent Application Publication
(10) Pub. No.: US 2013/0107524 A1
(43) Pub. Date: May 2, 2013

(54) LIGHT ENGINES FOR LUMINAIRES

(71) Applicants: Ormand Gilbert Anderson, JR., Woodstock, GA (US); Chad Everett Arceneaux, Atlanta, GA (US)

(72) Inventors: Ormand Gilbert Anderson, JR., Woodstock, GA (US); Chad Everett Arceneaux, Atlanta, GA (US)

(21) Appl. No.: 13/286,468

(22) Filed: Nov. 1, 2011

(51) Int. Cl. F21V 5/04

(52) U.S. Cl. 362/237; 362/244

(57) ABSTRACT

Light engines for luminaires that include a printed circuit board of a geometric shape, light emitting diodes provided on the PCB, and an optic that is mounted on the PCB to cover the LEDs. One or a plurality of light engines may be mounted in a luminaire. The light engines may be arranged in any orientation within a luminaire and such arrangement may be specifically tailored to the geometric shape of the luminaire, if desired. The light engine design of embodiments contemplated herein allows customization of the pattern of emitted light from a luminaire, which is impacted by the type of optic (i.e., Type I-V) incorporated into each light engine in the luminaire and the rotational orientation of each optic in such light engines.

### FIELD

Embodiments of the present invention relate to light engines for luminaires.

### BACKGROUND

Most luminaires that use light emitting diodes (“LEDs”) are powered by light boards of rectangular shape with the LEDs laid out on the light boards in a rectangular grid or a line of LEDs. Light boards of this shape are not conducive to inclusion in, or configurable for inclusion in, a wide variety of luminaire shapes.

The optics for use with such light boards usually include Type I, Type II, Type III, Type IV, or Type V lenses. These lens types are well known in the industry and represent the distribution pattern that light will have when exiting the lenses. The lenses used with light boards in typical LED luminaires are typically all of the same distribution (i.e., are all Type I or of Type II, etc.) such that all of the light exiting the luminaire is aimed in a specified and predetermined direction.

### SUMMARY

Certain embodiments of the present invention provide light engines for luminaires. Embodiments of the light engines include a printed circuit board (“PCB”) of a geometric shape, light emitting diodes (“LEDs”) provided on the PCB, and an optic that is mounted on the PCB to cover the LEDs.

Other embodiments are directed to luminaires in which one or a plurality of such light engines are mounted. The light engines may be arranged in any orientation within a luminaire and such arrangement may be specifically tailored to the geometric shape of the luminaire, if desired. The light engine design of embodiments contemplated herein allows customization of the pattern of emitted light from a luminaire, which is impacted by (1) the type of optic (i.e., Type I-V) incorporated into each light engine in the luminaire and (2) the rotational orientation of each optic in the light engines. In some embodiments, the direction that light emitted from the LEDs is aimed by the optic may be altered by rotationally altering the position of the optic relative to its associated PCB.

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

### BRIEF DESCRIPTION OF THE FIGURES

Illustrative embodiments of the present invention are described in detail below with reference to the following drawing figures:

FIG. 1 is an exploded view of one embodiment of a light engine.

FIG. 2 is a perspective view of the light engine of FIG. 1 assembled.

FIG. 3 is an exploded view of another embodiment of a light engine.

FIG. 4 is a perspective view of the gasket shown in FIG. 3 mounted on the PCB shown in FIG. 3.

FIG. 5 is an enlarged section view taken at inset 5 in FIG. 4.

FIG. 6 is a perspective view of the light engine of FIG. 3 assembled.

FIG. 7 is a partial perspective view of a luminaire in which light engines according to some embodiments are positioned.

FIGS. 8A-8X are schematic illustrations of light engines in various configurations according to some embodiments of the invention.

FIGS. 9A-D illustrate light engines according to embodiments of the invention positioned within luminaires of different shapes.

FIG. 10 is an exploded view of an embodiment of a wall sconce illuminated by an embodiment of a light engine.

FIG. 11 schematically illustrates embodiments of light engines connected to power sources.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

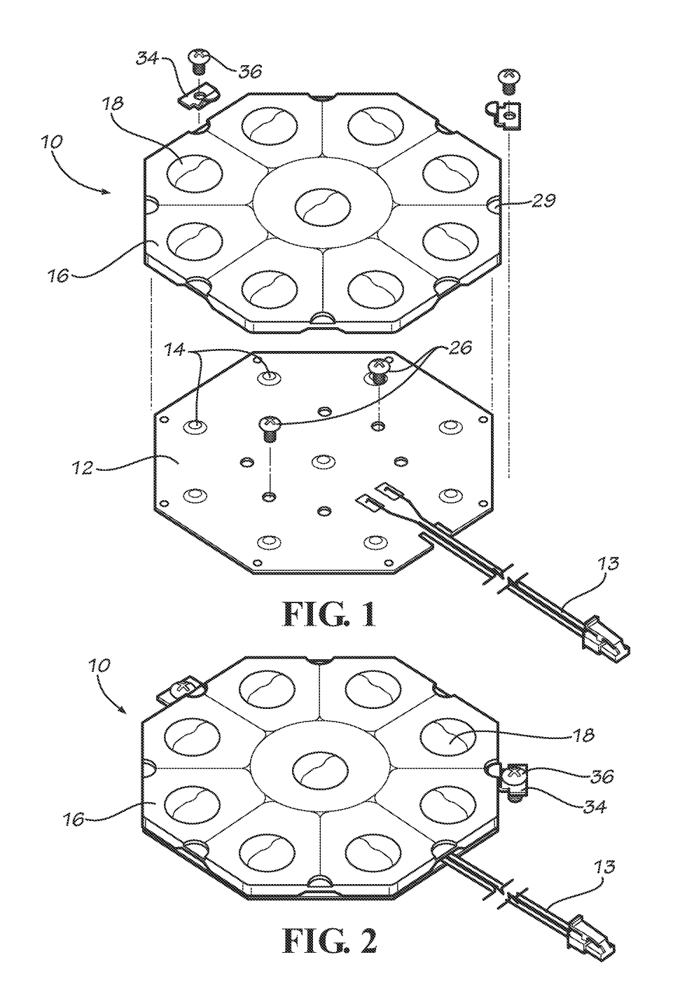

Certain embodiments of the present invention provide light engines 10 for luminaires. Embodiments of the light engines include a printed circuit board (“PCB”) 12, light emitting diodes (“LEDs”) 14 provided on the PCB 12, and an optic 16 that is mounted on the PCB 12 to cover the LEDs 14. A illustrative example of an embodiment of a light engine 10 is shown in FIG. 1. While the light engines disclosed herein are discussed for inclusion in luminaires, they may be used in any application.

The PCB 12 can be any geometric shape, including, but not limited to, square, rectangular, triangular, pentagonal, hexagonal, octagonal, circular, oval, or any equilateral or non-uniform geometric shape. Hexagonal and octagonal PCBs 12 are shown throughout this disclosure for purposes of illustration; however, embodiments are certainly not intended to be limited to such shapes. Wire leads 13 are connected to and extend from the PCB 12.

A plurality of LEDs 14 are mounted on the PCB 12. The LEDs may be single-die or multi-die LEDs, DC or AC, or can be organic light emitting diodes. White, color, or multicolor LEDs may be used. Moreover, the LEDs 14 mounted on a PCB 12 need not all be the same color; rather, mixtures of LEDs 14 may be used.

Any number of LEDs 14 may be mounted on a PCB 12 in any configuration. In some embodiments, the LEDs 14 are mounted on a PCB 12 in a polar array about a center point (as seen in FIG. 1) but such configuration need not be the case. The shape of the PCB 12 may help to dictate natural arrangements of the LEDs 14 on the PCB 12.

An optic 16 is positioned over each PCB 12. In some embodiments, the optic 16 can be, but does not have to be, the same shape and size of the PCB 12 on which it is mounted. The optic 16 includes a plurality of lenses 18 formed integrally in the optic 16 (such as by molding). The optic 16 may be formed from a transparent material, such as, but not limited to, polymeric materials (e.g., polycarbonate or acrylic), glass, topaz, sapphire, epoxy resin, etc. In some embodiments, the lenses 18 of an optic 16 are identical in that they are all of a single type (e.g., all Type I lenses, all Type II lenses, all Type III lenses, all Type IV lenses, all Type V lenses). In other embodiments, a single optic 16 may be provided with lenses 18 of different Types I-V. In some embodiments, there is a 1:1 correspondence between the number of lenses 18 on the optic 16 and the number of LEDs 14 on the PCB 12.

As shown in FIG. 2, the optic 16 is positioned over the PCB 12 so that the lenses 18 of the optic 16 align with the LEDs 14 mounted on the PCB 12. In some embodiments, the lenses 18 are centered directly on the LEDs 14. The optic 16 may be retained on the PCB 12 using any mechanical retention method. In some embodiments, the retention method is non-permanent, thereby permitting the optic to be removed from the PCB or to move (such as via rotation) relative to the PCB, as explained below. In the illustrated embodiment of FIG. 2, the optic 16 fits over the sides of the PCB 12.

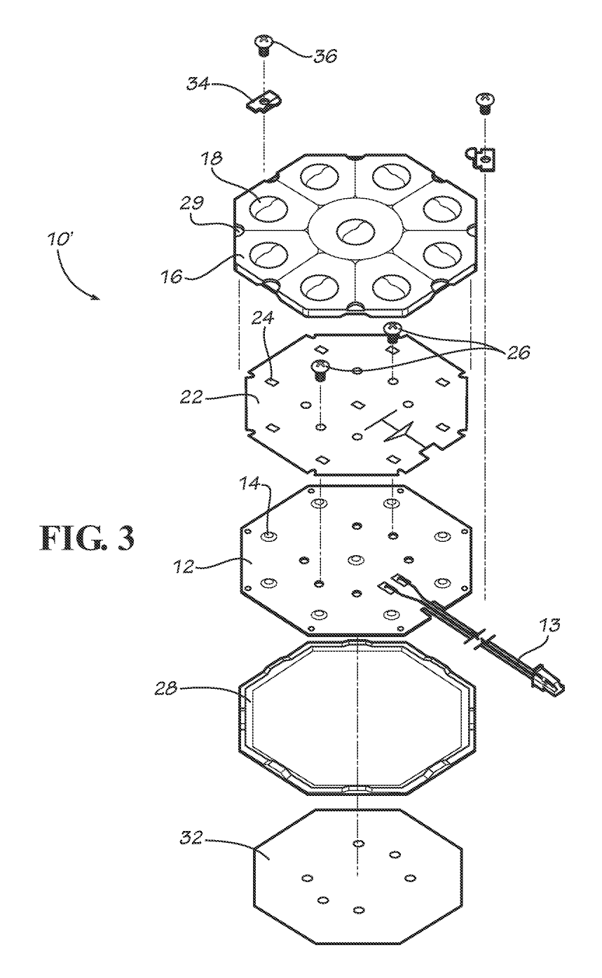

FIG. 3 is an exploded view of an alternative embodiment of a light engine 10′. Flame barrier 22 is interposed between the PCB 12 and optic 16. The flame barrier may be manufactured from any material having suitable insulating properties, including, but not limited to, flame resistant polymeric materials, glass, or metal. In some embodiments, 3M™'s CeQUIN™ insulating paper may be suitable. The flame barrier 22 includes LED apertures 24 through which the LEDs 14 mounted on PCB 12 may pass. The flame barrier 22 is optional and may not be needed in all applications.

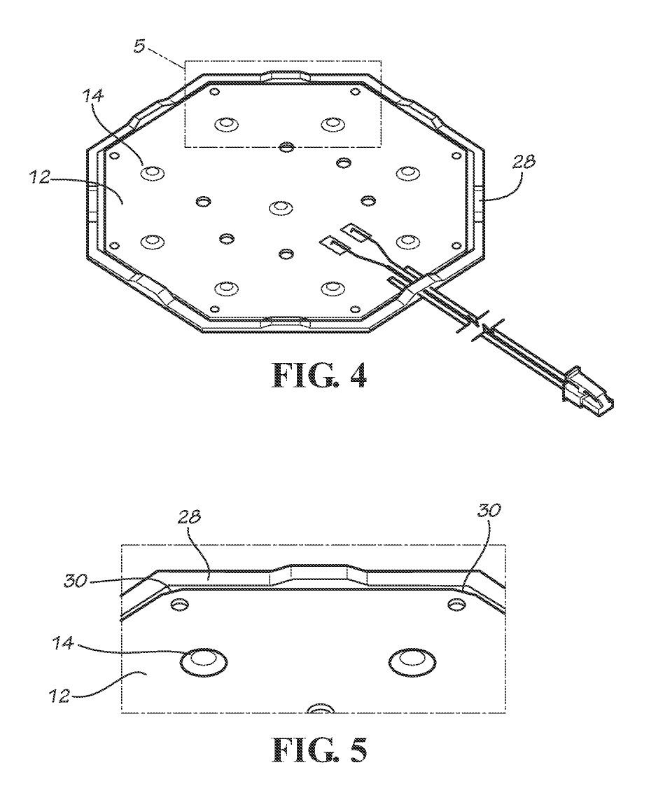

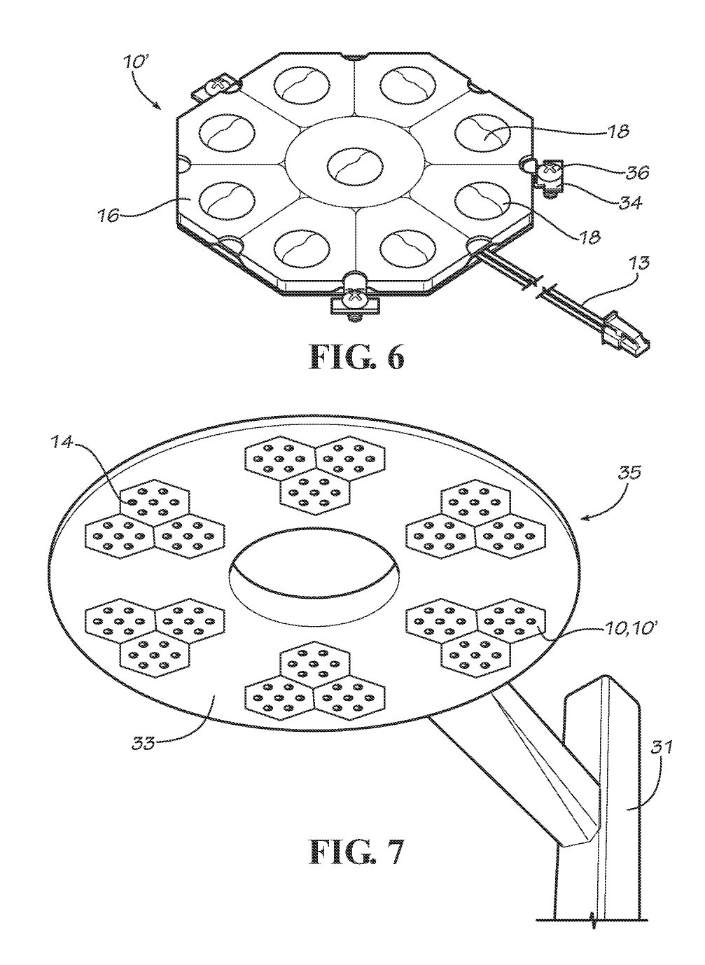

Light engine 10′ further includes a gasket 28 that is adapted to surround the periphery of PCB 12 (see FIG. 4). The gasket 28 may include tabs 30 that fit over the corners of the PCB 12 to secure the gasket 28 to the PCB 12, as shown in FIG. 5. The gasket 28 includes a slot for passage of the wire leads 13 coming off the PCB 12. A thermally-conductive pad 32 may optionally be provided on the underside of the PCB 12 for thermal management purposes and more specifically for providing a path for dissipating heat generated by the LEDs 14.

In use, a plurality of light engines 10, 10′ are mounted in a luminaire 31 (such as that shown in FIG. 7). In some embodiments, the light engines 10, 10′ are mounted to a metal casting 33 within the luminaire head 35. In the embodiment illustrated in FIG. 3, the thermally-conductive pad 32 would be interposed between the underside of the PCB 12 and the casting 33.

Any retention method may be used to secure the light engines 10, 10′ to the metal casting 33. By way only of example, screw(s) 26 may be provided to secure the PCB 12 (FIG. 2) or the flame barrier 22 (if provided), PCB 12, and thermally-conductive pad 32 (if provided) (FIG. 3) to the metal casting 33. Clips 34 with associated mounting screws 36 may then be used to secure the optic 16 over the mounted PCB 12 (FIG. 2) or the mounted flame barrier 22 (if provided)/PCB 12/thermally-conductive pad 32 (if provided) (FIG. 3). In some embodiments, the optic 16 is provided with indentations 29 for receiving the arms of the clips 34. Any number of clips 34 may be used and indentations 29 be provided. In use, the clips can be rotated (or loosened and rotated) so as to disengage the optic 16 and thereby permit rotation of the optic 16. The clips 34 can then be re-secured over the optic 16 to hold the optic 16 in place in the desired rotational orientation. Any number of alternative mounting means and configurations may be used. For example, instead of clips 34, screws, brackets, or biasing elements (such as springs) may be used to retain the optic 16 over the PCB 12. Moreover, it is possible that the flame barrier 22 not be secured at all with screws 26 but rather just interposed between the PCB 12 and the optic 16. Alternatively, the flame barrier 22 could be mounted on pins extending from the optic 16 or from the PCB 12.

In some embodiments, the light engines used in a luminaire are all identical in that they have identically-shaped and sized PCBs 12, the same number and arrangement of LEDs 14 on the PCBs 12, and/or the same type of optic 16 mounted on each PCB 12. However, in other embodiments, the light engines provided in a luminaire need not be identical. Rather, PCBs 12 of different shapes and sizes may be used in a single luminaire. Moreover, the number and arrangement of LEDs 14 on such PCBs 12 can differ, and optics 16 having lenses 18 with different distributions may be used in a single luminaire. By way only of example, one light engine in a luminaire may have an optic 16 with Type II lenses 18 while another light engine in the luminaire may have an optic 16 with Type III lenses 18.

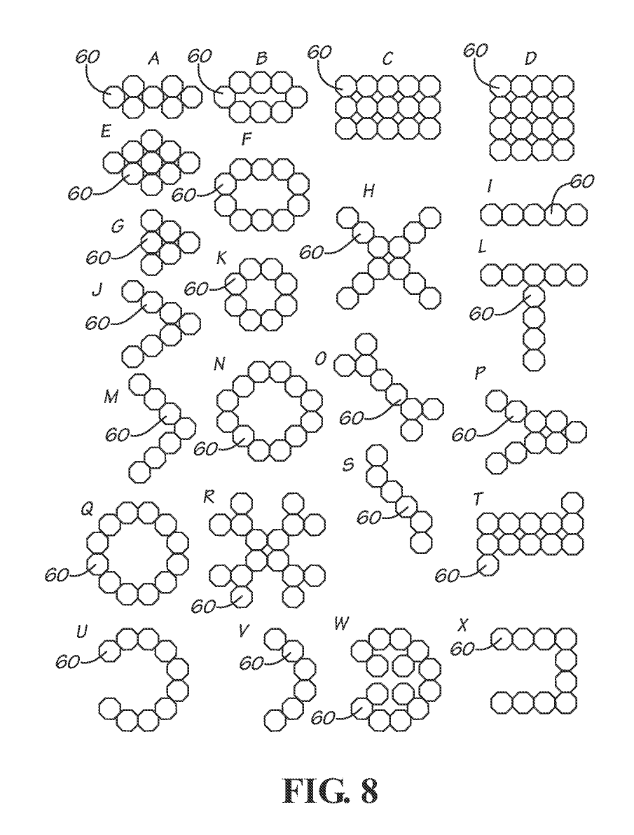

The light engines may be arranged in any orientation within a luminaire and such arrangement may be specifically tailored to the geometric shape of the luminaire, if desired. FIGS. 8A-8X schematically represent octagonal light engines (indicated generally as 60) arranged in a variety of different configurations (e.g., clustered, circular, semi-circular, oval, rectangular, square, diamond, linear, T-shaped, X-shaped, V-shaped, U-shaped, cross, serpentine, or triangular configuration). As stated earlier, however, the light engines may be of any geometric shape. The geometric shape of the PCBs 12 renders them suitable for use in a variety of luminaires having different shapes and features. For example, the light engine 60 configuration of FIG. 8C would be well-suited in a luminaire having a rectangular head. The light engine 60 configuration of FIG. 8D would be well-suited in a luminaire having a square head. The light engine 60 configuration of FIG. 8Q would be well-suited in a luminaire having a circular head with a central opening in the head. FIGS. 8A-8X represent but a few of the endless possibilities of light engine configurations. Moreover, the light engine configurations need not match the shape of the luminaire. For example, the light engines could be installed in a circular pattern within a rectangular luminaire head.

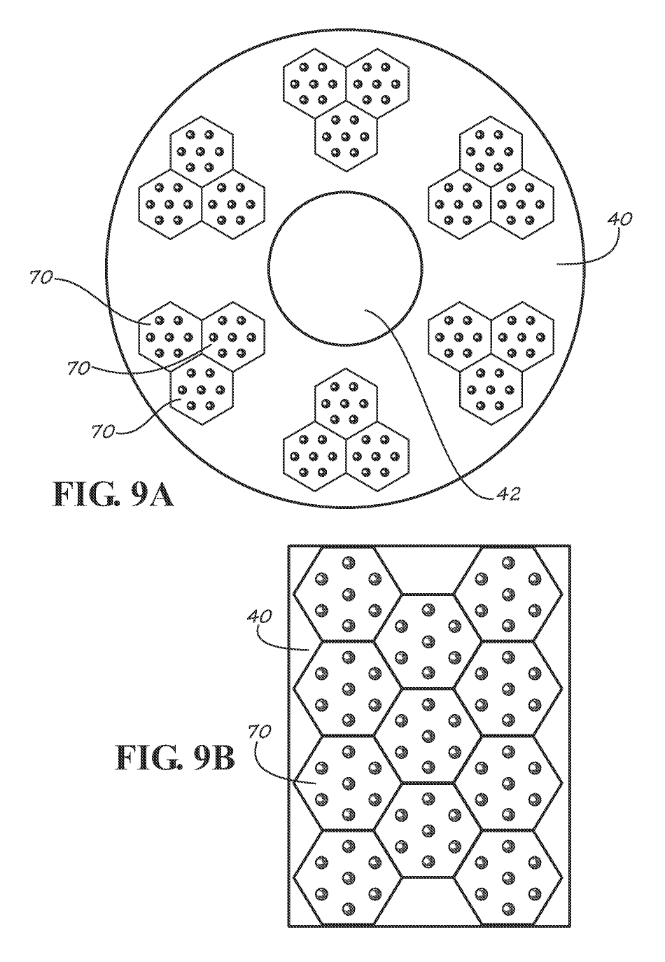

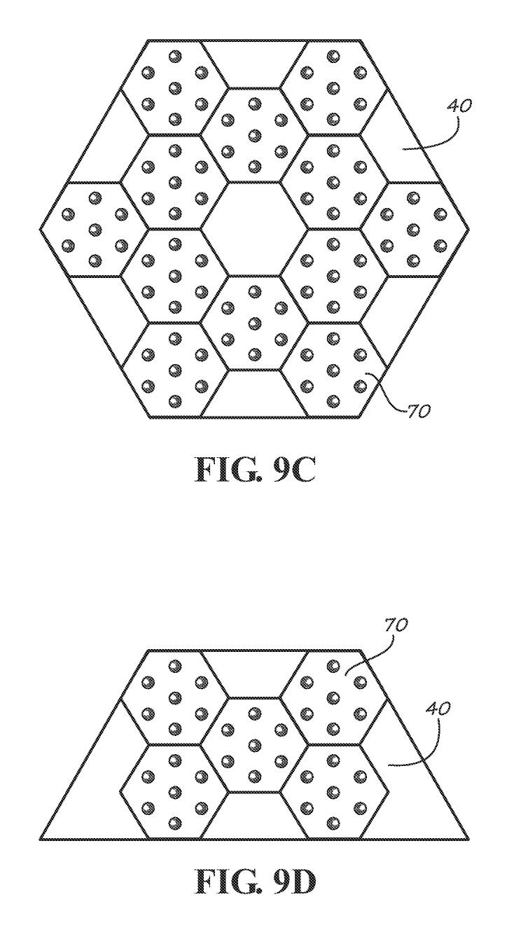

FIGS. 9A-D illustrate hexagonal light engines (indicated generally as 70) arranged in different configurations. In FIG. 9A, the luminaire head 40 is circular with a central, circular aperture 42 (such as is shown in the luminaire of FIG. 7). The light engines 70 are arranged in clusters of three light engines 10 around the aperture 42. In FIG. 9B, the light engines 70 are arranged within a rectangular luminaire head 40. In FIG. 9C, the light engines 70 are arranged within a hexagonal luminaire head 40. In FIG. 9D, the light engines 70 are arranged within a trapezoidal luminaire head 40.

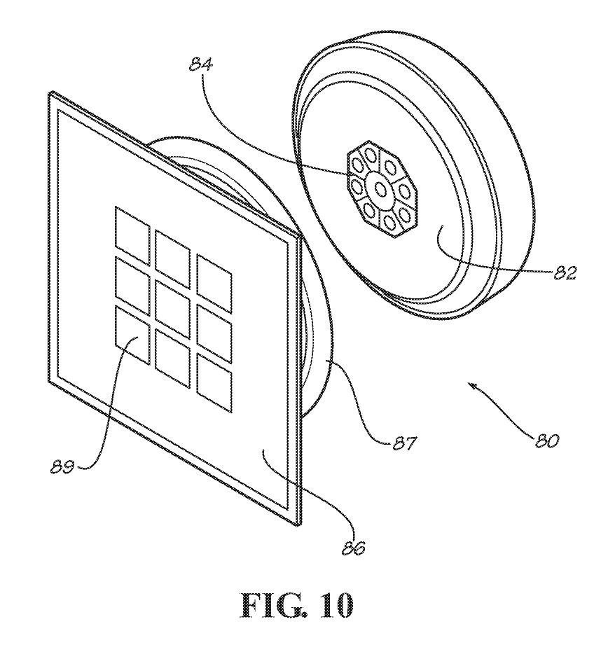

FIG. 10 illustrates an exploded view of another embodiment of a luminaire, and more particularly a wall sconce 80. The wall sconce 80 includes a metal casting 82 with a light engine 84 (such as those disclosed above) mounted on the casting 82. Multiple light engines 84 could be used. A face plate 86 is secured over the metal casting 82 (such as via coupling 87). In some embodiments, the face plate 86 includes a design or logo 89. The face plate 86 can be any shape and is not limited to the square shape illustrated in FIG. 10. In use, the wall sconce 80 is mounted on a wall so that the face plate 86 is exposed on the wall. It may be desirable for some of the light to be distributed directly outwardly through the face plate 86 to illuminate any design or logo 89 on the face plate 86 and for other of the light to be distributed radially outwardly from the wall sconce 80 so as to illuminate the wall around the wall sconce 80 (e.g., the periphery of the face plate 86). To accomplish this distribution, the lenses on the optic of the light engine 84 may have different distributions. By way only of example, the center LED of light engine 84 could have an associated lens designed to distribute the LED's emitted light directly outwardly from the PCB while each of the surrounding eight LEDs could have an associated lens designed to distribute the LED's emitted light radially outwardly from the PCB.

Using geometrically-shaped PCBs 12 ensures that the edges and/or corners of adjacent light engines can contact each other if desired. This can facilitate electrically connecting the light engines to a power source, as discussed below.

The light engines may be powered in a variety of different ways. In some embodiments, a single driver is provided, and each light engine is separately connected to the driver (e.g., such as by using connectors to connect leads from the light engines to a wiring harness from the driver). In another embodiment, a first light engine is connected to the driver and the other light engines are connected in series to the first light engine. By way only of example, the hexagonal light engines 70 shown in FIGS. 9A-D could be connected at the corners where adjacent light engines 70 meet.

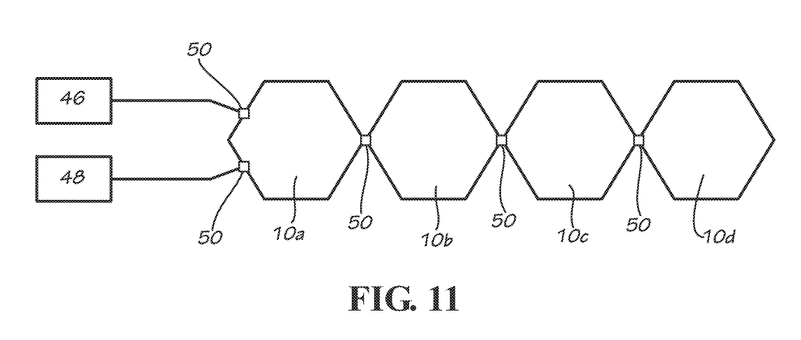

In still another embodiment, multiple drivers are provided, each of which is connected to a first light engine 10a. The remaining light engines 10b-10d are connected in series to the first light engine 10a. This arrangement is shown schematically in FIG. 11 where a first driver 46 and second driver 48 are connected to a first light engine 10a. Light engines 10b-10d are connected in series to first light engine 10a with connectors 50. Bypass circuits may be used so that the a circuit can pass through a light engine without energizing the LEDs on that particular light engine but can energize other light engines in the series. By way only of example, using such bypass circuits a driver can energize every other light engine in the series. For example, in the example shown in FIG. 11, first driver 46 could energize light engines 10a and 10c and second driver 48 could energize light engines 10b and 10d.

The light engine design of embodiments contemplated herein allows customization of the pattern of light emitted from a luminaire. The light distribution is impacted by (1) the type of optic 16 (i.e., Type I-V) incorporated into each light engine in the luminaire and (2) the rotational orientation of each optic 16 in such light engines.

In some embodiments, optics 16 having lenses 18 with identical optical properties are used in all of the light engines in a luminaire. In other embodiments, light engines having lenses 18 with different distributions or optical properties can be provided in a single luminaire. The overall light distribution of the luminaire is tailored by coupling each PCB 12 with an optic 16 designed to distribute the light from the LEDs 14 on the PCB 12 as desired.

Because the optics 16 are releasably attached to, or otherwise movable relative to, the PCBs 12, the direction that the light emitted from the LEDs 14 on a PCB 12 is aimed by the optic 16 may be altered by rotationally altering the position of the optic 16 relative to its associated PCB 12. The optics 16 may be rotated in any suitable increment, which will be dependent upon the shape of the PCB 12 and/or the location of the LEDs 14 on the PCB 12. For example, if the PCB 12 is square, in some embodiments the optic 16 could be rotated in 90° increments. If the PCB 12 is hexagonal or octagonal, in some embodiments the optic 16 could be rotated in 60° and 45° increments, respectively. Thus, in some embodiments, the light emitted from the LEDs 14 mounted on different PCBs 12 in the luminaire is aimed in specific directions to create a unique or customized light distribution simply by adjusting the rotational position of some of all of the optics 16 relative to their associated PCBs 12. In this way, a customer can customize the light distribution of the luminaire in the field by aiming the optics 16 as desired.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

We claim:

1. A light engine comprising:
a printed circuit board having a size and a shape, wherein the shape is one of a square, a rectangle, a triangle, a pentagon, a hexagon, or an octagon;
a plurality of light emitting diodes positioned on the printed circuit board; and
an optic comprising a plurality of lenses formed integrally in the optic, wherein the optic is positioned over the printed circuit board so that each of the plurality of lenses seats over one of the plurality of light emitting diodes,
wherein the optic is rotatable relative to the printed circuit board.

2. The light engine of claim 1, wherein the printed circuit board comprises a center point and wherein the plurality of light emitting diodes are positioned on the printed circuit board in a polar array about the center point.

3. The light engine of claim 1, wherein the optic comprises a shape and a size identical to the shape and the size of the printed circuit board, respectively.

4. The light engine of claim 1, wherein each of the plurality of lenses comprises a lens type and wherein the lens type of each of the plurality of lenses is identical.

5. The light engine of claim 1, wherein each of the plurality of lenses comprises a lens type and wherein the lens type of at least some of the plurality of lenses is different.

6. The light engine of claim 1, wherein the printed circuit board comprises a plurality of edges that meet a corners, wherein the light engine further comprises a gasket positioned around the plurality of edges of the printed circuit board.

7. The light engine of claim 6, wherein the gasket comprises tabs that are positioned over the corners of the printed circuit board.

8. The light engine of claim 1, wherein the printed circuit board comprises an underside and wherein the light engine further comprises a thermally-conductive pad positioned on the underside of the printed circuit board.

9. A luminaire comprising a plurality of light engines assembled in the luminaire, wherein each light engine comprises:
a printed circuit board having a size and a shape;
a plurality of light emitting diodes positioned on the printed circuit board; and
an optic comprising a plurality of lenses formed integrally in the optic, wherein the optic is positioned over the printed circuit board so that each of the plurality of lenses seats over one of the plurality of light emitting diodes,
wherein the optic is rotatable relative to the printed circuit board.

10. The luminaire of claim 9, wherein the luminaire comprises a luminaire head having a shape and wherein at least some of the plurality of light engines are assembled in the luminaire head in a light engine configuration shape, wherein the luminaire head shape and the light engine configuration shape are substantially the same.

11. The luminaire of claim 9, wherein the plurality of light engines are assembled in the luminaire in substantially a clustered, a circular, a semi-circular, an oval, a rectangular, a square, a diamond, a linear, a t-shaped, an x-shaped, a v-shaped, a u-shaped, a cross, a serpentine, or a triangular configuration.

12. The luminaire of claim 9, wherein the shape of the printed circuit board of each of the plurality of light engines is identical.

13. The luminaire of claim 9, wherein each of the plurality of lenses of each of the plurality of light engines comprises a lens type and wherein the lens type of all of the plurality of lenses of at least one of the plurality of light engines is identical.

14. The luminaire of claim 9, wherein each of the plurality of lenses of each of the plurality of light engines comprises a lens type, wherein the lens type of all of the plurality of lenses of one of the plurality of light engines is a first type, and wherein the lens type of all of the plurality of lenses of another of the plurality of light engines is a second type different from the first type.

15. The luminaire of claim 9, wherein at least some of the plurality of light engines are assembled in the luminaire so that an edge of the at least some of the plurality of light engines abuts an edge of an adjacent light engine.

16. The luminaire of claim 15, wherein at least some of the plurality of light engines are electrically connected at the abutting edges.

17. The luminaire of claim 9, Wherein three of the plurality of light engines are assembled in the luminaire so that an edge of each of the three light engines abuts an edge of the other of the three light engines and wherein the abutting edges of the three light engines form a corner.

18. The luminaire of claim 17, wherein the three light engines are electrically connected at the corner.

19. The luminaire of claim 9, wherein the luminaire further comprises a driver and wherein at least some of the plurality of light engines are connected in series to the driver.

20. The luminaire of claim 9, wherein the luminaire further comprise a first driver and a second driver, wherein at least some of the plurality of light engines are connected in series to the first and second driver, and wherein the first and second driver each activate different of the at least some of the plurality of light engines.

21. A method of customizing a desired light distribution of a luminaire using a plurality of light engines, each light engine having a light distribution and comprising:
a printed circuit board;
a plurality of light emitting diodes positioned on the printed circuit board;
an optic comprising a plurality of lenses formed integrally in the optic, wherein:
the optic is positioned over the printed circuit board so that each of the plurality of lenses seats over one of the plurality of light emitting diodes;
each of the plurality of lenses comprises a lens type; and
the optic is able to rotate relative to the printed circuit board, the method comprising:
a. selecting a plurality of light engines based on the light distribution of each of the plurality of light engines; and
b. positioning the plurality of light engines in the luminaire.

22. The method of claim 21, further comprising rotating the optic of at least one of the plurality of light engines to alter the light distribution of the at least one of the plurality of light engines.

23. The method of claim 21, wherein the lens type of all of the plurality of lenses of one of the plurality of light engines is a first type and wherein the lens type of all of the plurality of lenses of another of the plurality of light engines is a second type different from the first type.

24. A luminaire comprising:
a. at least one light engine comprising:
i. a printed circuit board;
ii. a plurality of light emitting diodes positioned on the printed circuit board; and
iii. an optic comprising a plurality of lenses formed integrally in the optic and each having a lens type, wherein the optic is positioned over the printed circuit board so that each of the plurality of lenses seats over one of the plurality of light emitting diodes,
b. a face plate positioned over the at least one light engine,
wherein the lens type of at least one of the plurality of lenses is adapted to distribute light primarily outwardly through the face plate and the lens type of at least one of the plurality of lenses is adapted to distribute light primarily radially outwardly from the luminaire.

25. The luminaire of claim 24, wherein the luminaire comprises a wall sconce.
